(19) United States
(12) Patent Application Publication
(10) Pub. No.: US 2019/0138364 A1
(43) Pub. Date: May 9, 2019

(54) MULTI-PROCESSOR SYSTEM AND PROCESSOR MANAGEMENT METHOD THEREOF

(71) Applicant: MStar Semiconductor, Inc., Hsinchu Hsien (TW)

(72) Inventor: Chien-Hsing HUANG, Hsinchu Hsien (TW)

(21) Appl. No.: 15/873,027

(22) Filed: Jan. 17, 2018

(30) Foreign Application Priority Data
Nov. 6, 2017 (TW) 106138347

(51) Int. Cl. G06F 9/50; G06F 12/0806

(52) U.S. Cl. CPC G06F 9/5077; G06F 12/0806; G06F 9/5016

(57) ABSTRACT

A multi-processor system includes a register, a thread generating circuit, a flag determining circuit, a scheduler, an adjusting circuit and an interrupt controller. The register is recorded with availability of a predetermined processor with respect to a shared peripheral interrupt. The thread generating circuit receives multiple requests, and accordingly generates multiple threads to be executed. Each time the thread generating circuit is to generate a thread, the flag determining circuit determines a real-time flag of the thread according to an attribute of the thread. The scheduler selects the predetermined processor to execute a prioritized thread. The adjusting circuit sets, according to the real-time flag of the prioritized thread, the availability for the shared peripheral interrupt recorded in the register. The interrupt controller, while assigning interrupts, takes into account the availability recorded in the register.

This application claims the benefit of Taiwan application Serial No. 106138347, filed Nov. 6, 2017, the subject matter of which is incorporated herein by reference.

### BACKGROUND OF THE INVENTION

### Field of the Invention

The invention relates to a multi-processor system.

### Description of the Related Art

To enhance performance, in addition to personal computers and laptop computers, the number of consumer electronic products adopting a circuit structure having multiple independent central processors keeps increasing in the recent years. These processors are usually designed to be controlled by one single operating system, and are capable of supporting multiple applications to operation simultaneously. FIG. 1 shows a block diagram of the such multi-processor system. A multi-processor system 100 includes N processors (denoted as 110₁, 110₂, . . . and 110_{N}, collectively referred to as processors 110, where N is an integer greater than 1), a thread generating circuit 120, a global scheduler 130, N schedulers (denoted as 140₁, 140₂, . . . and 140_{N}, collectively referred to as schedulers 140), and an interrupt controller 150.

The thread generating circuit 120 receives requests from applications 191 to 194, and packages tasks, which are assigned by the applications and are to be executed by the processors 110, into multiple corresponding threads. The global scheduler 130, according to current work loads of the processors, decides how to distribute the threads generated by the thread generating circuit 120 to respective queues of the processors. The scheduler 140 corresponding to each processor 110 selects a thread having the highest priority from the queue, and has the processor 110 execute the selected thread.

The interrupt controller 150 receives an interrupt request (IRQ) issued from a circuit such as a memory, a timer and an image processing circuit, and forwards the interrupt request to the processors 110. In a multi-processor system, there are usually several types of interrupt requests, including per-processor interrupt requests and shared peripheral interrupt requests. A per-processor interrupt request refers to an interrupt request issued to a specific processor, and can only be processed by that specific processor. For example, a per-processor interrupt request is an interrupt request issued by a timer of a processor or an inter-processor interrupt request generated between two processors. In contrast, a shared peripheral interrupt request can be handled by any of the N processors 110.

In an operation logic of a common operating system, the priority of an interrupt request is higher than all threads. Each time a per-processor interrupt request arises, the corresponding specific processor suspends a currently on-going thread, and starts processing this per-processor interrupt request. On the other hand, each time a shared peripheral interrupt request arises, any processor 110 that is not currently processing other interrupt requests at the time joins a group of competing for entitlement of processing this shared peripheral interrupt request. The processor 110 having won the entitlement then starts processing this shared peripheral interrupt request; the thread originally being processed by this processor 110 is suspended and is placed back in the queue to wait, and is again executed when next selected by the scheduler 140 of the processor 110.

One drawback of the above approach is that, a problem can be resulted if a thread is suspended by the processor for too long due to the intervention of the interrupt request. In one typical situation, when a processor receives an interrupt request while processing a thread with high instancy, a suspension period of the thread may exceed a predetermined period, causing data loss of the thread or other errors. Taking a thread of a music playback application for example, if a thread currently being executed is abandoned halfway, the music originally being played may sound discontinuous or intermittent, leading to poor user experience.

### SUMMARY OF THE INVENTION

To solve the above issues, the present invention provides a multi-processor system and a processor management method thereof.

According to an embodiment of the present invention, a multi-processor system includes multiple processors, a register, a thread generating circuit, a flag determining circuit, a scheduler, an adjusting circuit and an interrupt controller. The register is recorded therein availability of a predetermined processor among the multiple processors with respect to a shared peripheral interrupt request. The thread generating circuit generates multiple threads to be executed by the multiple processors, wherein the multiple threads correspond to multiple applications. The flag determining circuit determines a real-time flag of one of the multiple threads at least according to an attribute corresponding to the thread, and provides the real-time flag to the thread generating circuit. The scheduler selects a prioritized thread to be executed by the predetermined processor from multiple threads assigned to the predetermined processor. The adjusting circuit sets in the register, according to the real-time flag of the prioritized thread, the availability of the predetermined processor to the shared peripheral interrupt request while the predetermined processor executes the prioritized thread. The interrupt controller assigns multiple interrupt requests to the multiple processors, and takes into account the availability recorded in the register when assigning the multiple interrupt requests. The plurality of interrupt requests include the shared peripheral interrupt request.

According to another embodiment of the present invention, a processor management method coordinating with a processor in a multi-processor system is provided. The management method includes: a) generating multiple threads to be executed, and determining a real-time flag for each of the threads according to an attribute of the thread; b) selecting a prioritized thread from multiple threads assigned to a predetermined processor, and setting, according to the real-time flag of the prioritized thread, availability of the predetermined processor with respect to a shared peripheral interrupt request when the predetermined processor executes the prioritized thread; and c) determining whether to assign the shared peripheral interrupt request to the predetermined processor according to the availability of the predetermined processor with respect to the shared peripheral interrupt request.

According to another embodiment of the present invention, a non-transient computer-readable storage medium applied to a multi-processor system is provided. The non-transient computer-readable storage medium stores a code that readable and executable by a processor. The code is for managing a processor in the multi-processor system. In the code, a first code is for generating multiple threads to be executed, and determining a real-time flag for each of the threads according to an attribute of the thread. A second code in the code is for selecting a prioritized thread from multiple threads assigned to a predetermined processor, and setting, according to the real-time flag of the thread, availability of the predetermined processor with respect to a shared peripheral interrupt request while the predetermined processor executes the prioritized thread. A third code in the code is for determining whether to assign the shared peripheral interrupt request to the predetermined processor according to the availability of the predetermined processor with respect to the shared peripheral interrupt request.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 (prior art) is a block diagram of a current multi-processor system;

FIG. 2 is a block diagram of a multi-processor system according to an embodiment of the present invention;

FIG. 3(A) and FIG. 3(B) are schematic diagrams of an interrupt mask register corresponding to a processor; and

FIG. 4 is a flowchart of a processor management method according to an embodiment of the present invention.

It should be noted that, the drawings of the present invention include functional block diagrams of multiple functional modules related to one another. These drawings are not detailed circuit diagrams, and connection lines therein are for indicating signal flows only. The interactions between the functional elements/or processes are not necessarily achieved through direct electrical connections. Further, functions of the individual elements are not necessarily distributed as depicted in the drawings, and separate blocks are not necessarily implemented by separate electronic elements.

### DETAILED DESCRIPTION OF THE INVENTION

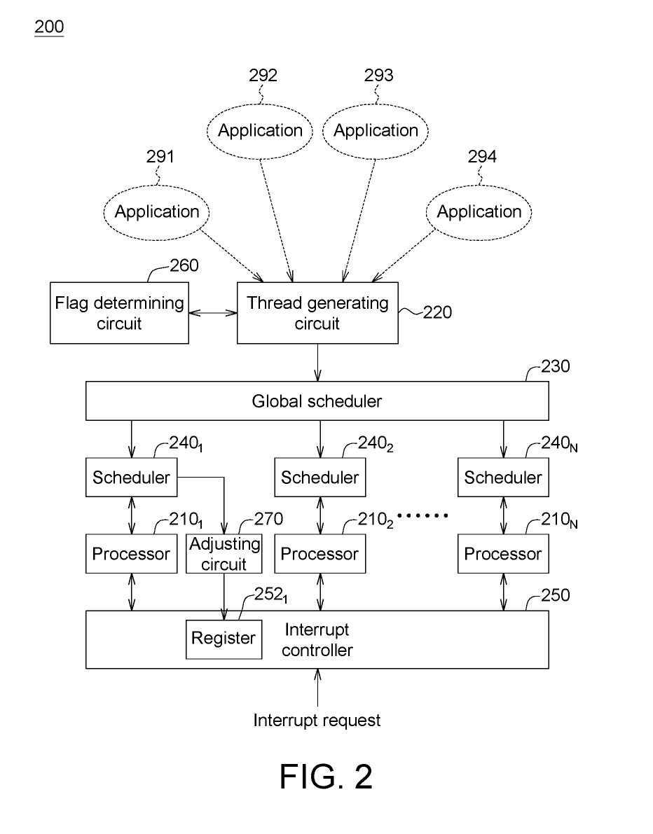

FIG. 2 shows a block diagram of a multi-processor system according to an embodiment of the present invention. A multi-processor system 200 includes N processors (denoted as 210₁, 210₂, . . . and 210_{N}, collectively referred to as processors 210, where N is an integer greater than 1), a thread generating circuit 220, a global scheduler 230, N schedulers (denoted as 240₁, 240₂, . . . and 240_{N}, collectively referred to as schedulers 240), an interrupt controller 250, a flag determining circuit 260, and an adjusting circuit 270.

The functions of the flag determining circuit 260 are in detail given below. The thread generating circuit 220 receives multiple thread requests from multiple applications 291 to 294, and accordingly generates threads to be executed by the processors 210. In the multi-processor system 200, each time the thread generating circuit 220 receives a request of generating a thread for a specific application, information associated with an attribute of the application or/and an attribute of the thread is received, and the information is provided to the flag determining circuit 260. The flag determining circuit 260 determines a real-time flag for the thread according to at least one of the above attributes, so as to indicate the urgency of whether this thread needs to be completed immediately and cannot be interrupted after it is executed. In practice, the real-time flag may be a binary flag. For example, the flag determining circuit 260 can set the flag as binary 1 to indicate that the thread has high instancy, and as binary 0 to indicate that the thread has low instancy. In other examples, the real-time flag generated according to the attribute of the application as well as the attribute of the thread may adopt a value between 0 and 1, with a higher value representing higher instancy.

In one embodiment, one of the application attributes that the flag determining circuit 260 uses as a determination basis is the main data type processed by the application. For example, the flag determining circuit 260 is configured to assign a high instancy flag to a thread that is corresponding to an application for playing multimedia data (e.g., a movie playback program or a karaoke application). Alternatively, writers of the applications 291 to 294 and a circuit designer of the flag determining circuit 260 may reach a consensus in advance—instancy of the threads from certain application is marked in the basic information of that application—, so as to allow the flag determining circuit 260 to be able to, after reading the basic information of the application, determine what type of real-time flag is to be assigned to the threads of the application. In another embodiment, for some threads belonging to the same application, the flag determining circuit 260 would individually flag the threads only according to the respective attributes of those threads.

The real-time flag determined by the flag determining circuit 260 is transmitted to the thread generating circuit 220. After receiving the real-time flag provided by the flag determining circuit 260, the thread generating circuit 220 generates and forwards a new thread including this real-time flag (e.g., writing the real-time flag to a specific field in the new thread), and forwards the new thread to the global scheduler 230 for further assignment. The global scheduler 230 determines how to assign threads according to respective workloads in the queues of the processors 210 and properties of the processors 210, etc. Associated operation logics are generally known to one person skilled in the art, and shall be omitted herein. Further, these operation logics do not form limitations to the scope of the present invention. The scheduler 240 of each of the processors 210 periodically selects one thread (to be referred to as a prioritized thread) from its queue and forwards the prioritized thread to the processor for further execution. For example, one prioritized thread is selected at one working cycle. In a situation where no interrupt requests need to be processed, each processor 210 follows the arrangement made by the respective scheduler 240, and executes the selected prioritized thread that the scheduler 240 selects for that working cycle.

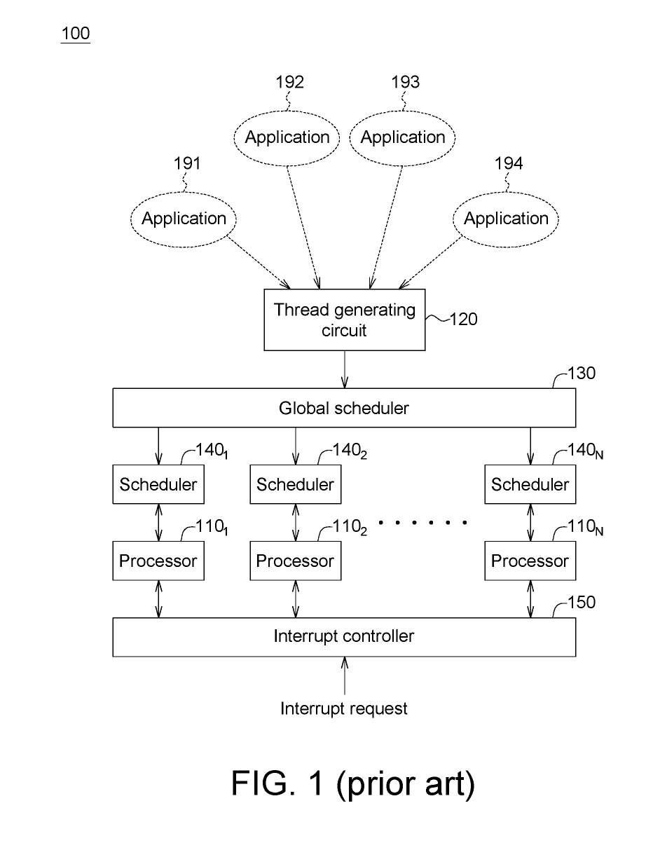

The interrupt controller 250 receives interrupt requests issued by circuits such as a memory, a timer and an image processor (not shown), and forwards the interrupt requests to the processors 210. As previously described, a per-processor interrupt request is issued to a specific processor and can be processed only by that specific processor; a shared peripheral interrupt request can be processed by any of the N processors 210. Different from the interrupt controller 150 in FIG. 1, the interrupt controller 250 is built with a register 252₁ for recording the availability of accepting a shared peripheral interrupt request by the processor 210₁. When assigning the entitlement for processing an interrupt request, the interrupt controller 250 refers to the content of the register 252₁. More specifically, when the content stored in the register 252₁ indicates that the processor 210₁ is currently unavailable for accepting a shared peripheral interrupt request, the interrupt controller 250 does not assign the processor 210₁ to process the shared peripheral interrupt request.

Referring to FIG. 2, the adjusting circuit 270 is coupled between the scheduler 240₁ and the interrupt controller 250. Each time the schedule 240₁ selects a prioritized thread for the processor 210₁, the adjusting circuit 270 sets the content of the register 252₁ according to the real-time flag of the prioritized thread, i.e., setting the availability of the processor 210₁ with respect to the shared peripheral interrupt request during the period of executing the prioritized thread. For example, a circuit designer can set the content of the register 252₁ as binary 1 to represent that the processor 210₁ cannot accept shared peripheral interrupt requests, and as binary 0 to represent that the processor 210₁ is able to take the shared peripheral interrupt request. If the flag determining circuit 260 similarly adopts binary 1 to represent high instancy and binary 0 to represent low instancy, the adjusting circuit 270 can adopt the real-time flag of the prioritized thread to set the content of the register 252₁. That is, a processor currently processing a prioritized thread having a high instancy flag cannot accept a shared peripheral interrupt request, whereas a processor currently processing a prioritized thread having a low instancy flag can accept a shared peripheral interrupt request. In one embodiment, the adjusting circuit 270 considers whether the real-time flag indicates that the instancy of the prioritized thread is higher than a predetermined threshold. For example, if the flag determining circuit 260 adopts a value between 0 and 1 as the real-time flag and a greater value represents higher instancy, the adjusting circuit 270 can regard a prioritized thread having a real-time flag greater than 0.5 as having high instancy, and thus sets the content of the register 252₁ to binary 1. Conversely, a prioritized thread having a real-time flag smaller than 0.5 is regarded by the adjusting circuit 270 as having low instancy, and so the content of the register 252₁ is set to binary 0.

With the collaboration of the flag determining circuit 260, the adjusting circuit 270 and the register 252₁, a thread having high instancy and processed by the processor 210₁ would not have the issue of being suspended due to the intervention of a shared peripheral interrupt request. In other words, when the content stored in the register 252₁ indicates that the processor 210₁ is currently unavailable for accepting a shared peripheral interrupt request, the interrupt controller 250 shields the processor 210₁ from accepting the shared peripheral interrupt request, and only allows a per-processor directed to the processor 210₁ to interrupt the thread currently being processed by the processor 210₁.

In practice, the interrupt controller 250 can use an interrupt mask register to record the availability of the processor 210 with respect to various interrupt requests, and the function of the register 252₁ can be integrated in the interrupt mask register corresponding to the processor 210₁. For example, assuming that the processor 210₁ is able to receive up to 15 types of interrupt requests, in which 3 are per-processor interrupt requests and 12 are shared peripheral interrupt requests. The interrupt mask register corresponding to the processor 210₁ may include a storage space for 15 bits (to be referred to as mask bits) respectively recording whether these 15 interrupt requests can be accepted by the processor 210₁. When the processor 210₁ can accept certain interrupt request, the mask bit corresponding to this interrupt request is set to binary 0. Conversely, when the processor 210₁ cannot accept certain interrupt request, the mask bit corresponding to this interrupt request is set to binary 1.

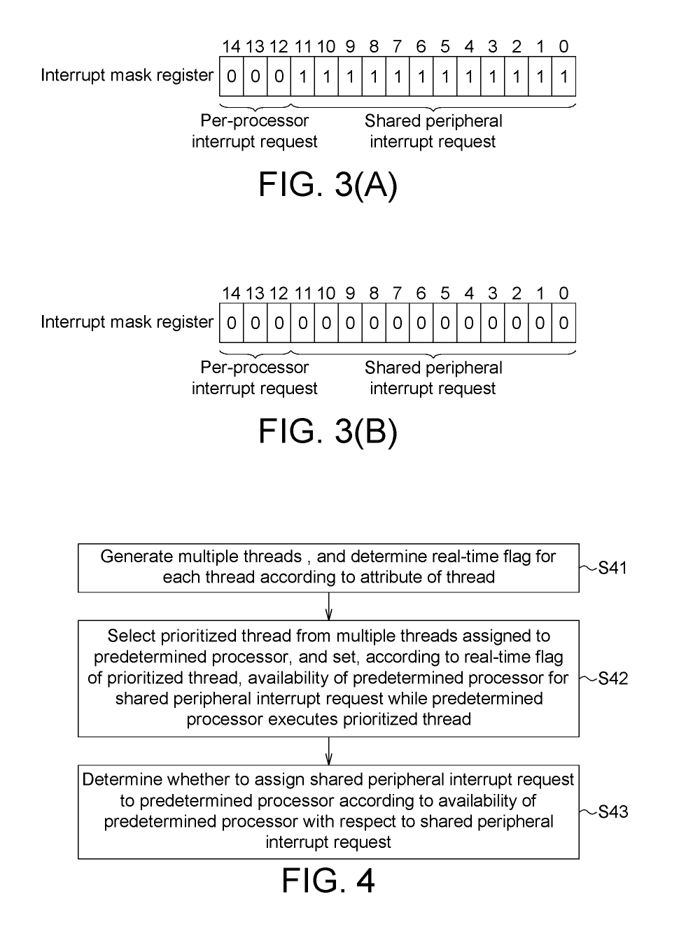

The adjusting circuit 270 may be designated with a capability for modifying the content of the interrupt mask register corresponding to the processor 210₁. FIG. 3(A) and FIG. 3(B) show schematic diagrams of an interrupt mask register corresponding to the processor 210₁. When the adjusting circuit 270 determines that the prioritized thread selected by the scheduler 240₁ has high instancy, the adjusting circuit 270 can set the contents of the interrupt mask registers corresponding to all 12 shared peripheral interrupt requests to binary 1, as shown in FIG. 3(A), thus shielding these interrupt requests. Only when the working cycle of the processor 210₁ for this prioritized thread has ended and the scheduler 240₁ again selects a new prioritized thread, the adjusting circuit 270 resets these twelve mask bits to binary 0. Conversely, when the adjusting circuit 270 determines that the prioritized thread selected by the scheduler 240₁ has low instancy, the adjusting circuit 270 does not operate, and the contents of the twelve mask bits are kept at binary 0. As shown in FIG. 3(B), in the above situation, when any type of shared peripheral interrupt request arises, the processing 210₁ will compete for the processing of this interrupt request.

In one embodiment, different types of shared peripheral interrupt requests may be assigned with different priorities. The priority of a certain type of shared peripheral interrupt requests may be higher than the above threads having high instancy. For example, assume that 4 of the 12 types of shared peripheral interrupt requests above have higher priorities. After the adjusting circuit 270 determines that the prioritized thread selected by the scheduler 240₁ has high instancy, the contents of the mask bits of only the remaining 8 types of shared peripheral interrupt requests, but not all of the 12 types of shared peripheral interrupt requests, are set to binary 1. In the above situation, with the collaboration of the flag determining circuit 260, the adjusting circuit 270 and the register 252₁, a thread with high instancy has a lower probability to be suspended by shared peripheral requests.

In practice, during the process of processing various types of interrupt requests, the interrupt controller 250 may also modify the content of a mask register. For example, while the processor 210₁ is currently processing a certain type of interrupt request, the interrupt controller 250 can set the content of the corresponding mask bit to binary 1. Associated operation details are generally known to one person skilled in the art, and shall be omitted herein.

It should be noted that, the approach of adjusting the availability for an interrupt request by the adjusting circuit 270 can be applied to multiple processors. For example, for the processor 210₂, an adjusting circuit 270 may be coupled between the scheduler 240₂ and the interrupt controller 250, so as to reduce the probability of suspending high instancy threads by the processor 210₂. Ideally, in a situation where the multi-processor system 200 includes N processors 210, N adjusting circuits 270 may be arranged, providing each processor 210 with one adjusting circuit 270. To reserve at least one processor 210 for processing shared peripheral interrupt requests, the scheduler 240 can be designed with a communication and coordination mechanism in a way that, at the same time point, at most (N−1) processors are available to process high instancy prioritized threads. Alternatively, the global scheduler 230 is configured to arrange the queues such that not all N queues have high instancy threads at the same time. In practice, a circuit designer can determine, according to the rule of thumb and an actual application, the number of the adjusting circuits 270.

In practice, the flag determining circuit 260 and the adjusting circuit 270 may be implemented as fixed and/or programmable digital logic circuits, including programmable logic gate arrays, application-specific integrated circuits, microcontrollers, microprocessors, digital signal processors and other necessary circuits.

Further, the scope of the present invention is not limited to controlling the multi-processor system 200 by a certain type of operating system.

A processor management method for coordinating with a processor in a multi-processor system is provided according to another embodiment of the present invention. FIG. 4 shows a flowchart of the processor management method. In step S41, multiple requests corresponding to multiple applications are received to accordingly generate multiple threads, and a real-time flag is determined for each of the threads according to an attribute of the thread. In step S42, a prioritized thread is selected from multiple threads assigned to a specific processor, and availability of the specific processor with respect to a shared peripheral thread while the specific processor executes the prioritized thread is set according to the real-time flag of the prioritized thread. In step S43, it is determined, according to the availability of the specific processor with respect to the shared peripheral interrupt request, whether to assign the shared peripheral interrupt request to the specific processor.

One person skilled in the art can understand that, the operation variations in the description associated with the multi-processor system 200 are applicable to the processor management method in FIG. 4, and shall be omitted herein.

A non-transient computer-readable storage medium applied to a multi-processor system is provided according to another embodiment of the present invention. The non-transient computer-readable storage medium stores a code readable and executable by a processor. The code is for managing a processor in the multi-processor system. In the code, a first code is for receiving multiple requests corresponding to multiple applications to accordingly generate multiple threads, and determining a real-time flag for each of the threads according to an attribute of the thread. A second code in the code is for selecting a prioritized thread from multiple threads assigned to a specific processor, and setting, according to the real-time flag of the thread, availability of the specific processor with respect to a shared peripheral interrupt request while the specific processor executes the prioritized thread. A third code in the code is for determining, according to the availability of the specific processor with respect to the shared peripheral interrupt request, whether to assign the shared peripheral interrupt request to the specific processor.

In practice, the non-transient computer-readable storage medium may be an electronic, magnetic or optic storage medium, e.g., a read-only memory (ROM), random access memory (RAM), CD-ROM, DVD, magnetic tape, floppy disk and hard drive. For example, the code can be compiled as a part of a code of an operating system. Further, the code may be compiled by various program languages.

One person skilled in the art can understand that, the operation variations in the description associated with the multi-processor system 200 are applicable to the non-transient computer-readable storage medium, and shall be omitted herein.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A multi-processor system, comprising:
a plurality of processors;
a register, recorded therein a value representing availability of a predetermined processor, among the plurality of processors, with respect to a shared peripheral interrupt request;
a thread generating circuit, generating a plurality of threads to be executed by the plurality of processors, the plurality of threads corresponding to a plurality of applications;
a flag determining circuit, coupled to the thread generating circuit, for each thread, determining a real-time flag of one of the threads at least according to an attribute corresponding to the thread;
a scheduler, selecting a prioritized thread to be executed by the predetermined processor from a plurality of threads assigned to the predetermined processor;
an adjusting circuit, setting in the register, according to the real-time flag of the prioritized thread, the availability of the predetermined processor with respect to the shared peripheral interrupt request while the predetermined processor executes the prioritized thread; and
an interrupt controller, assigning a plurality of interrupt requests to the plurality of processors, and taking into account the availability recorded in the register when assigning the plurality of interrupt requests, the plurality of interrupt requests comprising the shared peripheral interrupt request.

2. The multi-processor system according to claim 1, wherein if the real-time flag indicates that instancy of the prioritized thread is higher than a predetermined threshold, the adjusting circuit sets in the register the availability of the predetermined processor with respect to the shared peripheral interrupt request such that the predetermined processor does not accept any shared peripheral interrupt request while executing the prioritized thread.

3. The multi-processor system according to claim 1, wherein if the real-time flag indicates that instancy of the prioritized thread is lower than a predetermined threshold, the adjusting circuit sets in the register, the availability of the predetermined processor with respect to the shared peripheral interrupt request such that the predetermined processor accepts the shared peripheral interrupt request while executing the prioritized thread.

4. A processor management method, for coordinating with a predetermined processor in a multi-processor system, the management method comprising:
a) generating a plurality of threads to be executed, and determining a real-time flag for each of the threads according to an attribute of the thread;
b) selecting a prioritized thread from a plurality of threads assigned to the predetermined processor, and setting, according to the real-time flag of the prioritized thread, availability of the predetermined processor with respect to a shared peripheral interrupt request while the predetermined processor executes the prioritized thread; and
c) determining whether to assign the shared peripheral interrupt request to the predetermined processor according to the availability of the predetermined processor with respect to the shared peripheral interrupt request.

5. The processor management method according to claim 4, wherein step (c) comprises:
if the real-time flag indicates that instancy of the prioritized thread is higher than a predetermined threshold, setting the availability of the predetermined processor with respect to the shared peripheral interrupt request such that the predetermined processor does not accept any shared peripheral interrupt request while executing the prioritized thread.

6. The processor management method according to claim 4, wherein step (c) comprises:
if the real-time flag indicates that instancy of the prioritized thread is lower than a predetermined threshold, setting the availability of the predetermined processor with respect to the shared peripheral interrupt request such that the predetermined processor accepts the shared peripheral interrupt request while executing the prioritized thread.

7. A non-transient computer-readable storage medium, applied to a multi-processor system, storing a code readable and executable by a processor, the code for managing a predetermined processor in the multi-processor system and comprising:
a first code, generating a plurality of threads to be executed, and determining a real-time flag for each of the threads according to an attribute of the thread;
a second code, selecting a prioritized thread from a plurality of threads assigned to the predetermined processor, and setting, according to the real-time flag of the prioritized thread, availability of the predetermined processor with respect to a shared peripheral interrupt request while the predetermined processor executes the prioritized thread; and
a third code, determining whether to assign the shared peripheral interrupt request to the predetermined processor according to the availability of the predetermined processor with respect to the shared peripheral interrupt.

8. The non-transient computer-readable storage medium according to claim 7, wherein the third code is compiled as:
if the real-time flag indicates that instancy of the prioritized thread is higher than a predetermined threshold, setting the availability of the predetermined processor with respect to the shared peripheral interrupt request such that the predetermined processor does not accept any shared peripheral interrupt request while executing the prioritized thread.

9. The non-transient computer-readable storage medium according to claim 7, wherein the third code is compiled as:
if the real-time flag indicates that instancy of the prioritized thread is lower than a predetermined threshold, setting the availability of the predetermined processor with respect to the shared peripheral interrupt request such that the predetermined processor accepts the shared peripheral interrupt request while executing the prioritized thread.
